(19) United States
(12) Patent Application Publication
(10) Pub. No.: US 2007/0294500 A1
(43) Pub. Date: Dec. 20, 2007

(54) Methods and system to provide references associated with data streams

(76) Inventors: Michael A. Falco, Swampscott, MA (US); Neil T. Hentschel, North Andover, MA (US); Brittain S. McKinley, Groton, MA (US); Mark J. Rutan, Northborough, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(21) Appl. No.: 11/454,249

(22) Filed: Jun. 16, 2006

(51) Int. Cl. G06F 12/00

(52) U.S. Cl. 711/170

(57) ABSTRACT

Each set of pointers inserted into a received data stream eventually includes pointer values that point to other locations (e.g., other segments) within the data stream. Initially, pointer values can be set to null values because an address or respective index to other segments or other sets of pointers in the data stream may not be known until they are either received from the live feed or inserted into the data stream. As new segments of data are received from an original data stream such as a live feed, a processing function herein backfills the null pointer values in the set of pointers with appropriate values to the newly received segments or set of pointers. Backfilling of appropriate pointer values into the data stream enables a respective user viewing the data stream to initiate navigation amongst the data stream and potentially view a live feed with little or no delay.

### BACKGROUND

Conventional technology has made it possible to more quickly and efficiently convey information to corresponding subscribers. For example, in the cable network space, digital cable now offers a multitude of channels to subscribers for receiving different types of streamed data content for playback on a respective television.

According to conventional cable technology, respective subscribers sometimes have so-called set top box devices in their homes that receive encoded digital information transmitted from a corresponding cable company. Upon receipt of the encoded data, the set top box decodes one of multiple channels selected by a television viewer. Once decoded, a respective set top box in a viewer's home drives a corresponding television system with an appropriate “rasterized” signal of decoded data derived from the selected channel. Accordingly, a television viewer is able to view a corresponding television program transmitted by the cable company and received by a corresponding set top box.

In certain circumstances, in lieu of transmitting a pre-recorded movie or video stream, the cable company transmits one or more live feeds for viewing by respective viewers. An example of a live feed is a real-time video clip generated by a news company. The news company feeds so-called live video to the cable company. The cable company, in turn, distributes respective content associated with the live feed to respective subscribers.

### SUMMARY

One deficiency associated with conventional transmission of content is the ability of a respective viewer to control navigation amongst a respective data stream received by a set top box. For example, as discussed above, conventional feeds (e.g., live or prerecorded data streams) from the cable company must be stored in a respective digital video recorder system in the user's home in order for the user to perform navigation in a respective stream. Otherwise, the received content cannot be replayed or navigated (e.g., via fast forward and rewind modes) by the viewer.

The following disclosure includes several useful embodiments for more efficiently processing a received data stream (e.g., a live data stream) and generating corresponding sets of pointers enabling navigation amongst a live data stream. For example, according to one embodiment, a system herein converts a received data stream (e.g., a raw data stream of video information) initially having no corresponding set of pointers to a respective data stream including inserted sets of pointers. The sets of pointers can include navigation (e.g., fast forwarding and/or rewind) pointers enabling a respective user viewing the data stream to initiate navigation amongst the data stream as well as view a live feed of the data stream in as near real-time as possible.

More particularly, in one embodiment, a respective processing function processes sequentially received segments of a live feed and inserts respective sets of pointers in the stream for purposes of enabling navigation by a user. For example, a respective processing function according to embodiments herein receives a first segment (e.g., a first logical portion of the live feed) of data and allocates a first storage region (e.g., a portion of the newly generated data stream) to maintain or store a set of pointers associated with the first segment of streaming data. The processing function is initially unable to assign values (e.g., address values) to at least a portion of “look-ahead” or fast forward pointers in the new data stream until receipt of following sequential segments of the received data stream.

Assume in this example that the processing function receives a second segment (e.g., a second logical portion of the live feed) of the streaming data following receipt of the first segment. After allocating the first storage region (e.g., in a respective repository such as memory, disk, etc.) as discussed above, the processing function allocates a second storage region (e.g., in the repository) to maintain a set of pointers associated with the second segment of streaming data. A location of the second storage region can depend at least in part on a length associated with the first segment of streaming data such that segments of content received in a respective data stream are interlaced with sets of pointers.

In one embodiment, each of the set of pointers in a newly generated data stream includes multiple pointer values to other segments in the data stream. For example, a first one of the pointers in the set of pointers can identify (e.g., in a forward or backwards direction) another segment in a respective received data stream one hop away (e.g., the very next segment); a second pointer in the respective set of pointers can point to a respective segment two hops away; a third pointer in the respective set of pointers can point to a respective segment four hops away; a fourth pointer in the respective set of pointers can point to a respective segment ten hops away, and so on.

In one embodiment, the respective pointers enable the user to navigate (e.g., via different fast forward and rewind speeds) amongst the data stream using the different pointer values. For example, a respective user can initiate a very fast rate of fast forwarding using the pointers to every respective following tenth segment in the data stream. A respective user can initiate a slower rate of fast forwarding (or rewinding) using respective pointers that point to every respective following next segment in the data stream.

As each new segment of data is received from a live feed, the processing function initially inserts an “empty” set of pointers. After receiving each successive segment or a number of successive segments, the processing function backfills the set of pointers to include appropriate forward-looking pointer values in the data stream. By initiating modification and backfilling of pointer values associated with the sets of pointers in a respective data stream, a respective user is able to control a rate of viewing the streaming data approximately up to a current position (e.g., near a real-time position) of the live feed.

Thus, according to one embodiment, techniques herein can be used to provide i) an ability to stream a live feed within seconds (e.g., a fixed number of frames or segments such as 5 or less seconds) of a start of ingest of the live feed (or an equivalent of a live feed), ii) an ability to pause a live feed within seconds of start of ingest of the live feed, iii) an ability to fast-forward to within seconds of the current point of a live feed after a stream has been paused or rewound, and iv) an ability to update memory without modifying the memory controller's high water mark within a block/tile.

Techniques herein are well suited for use in applications such as those that generate navigable data streams such as live data streams distributed to multiple subscribers. However, it should be noted that configurations herein are not limited to use in such applications and thus configurations herein and deviations thereof are well suited for other applications as well.

In addition to potentially being implemented via discrete hardware components such as logic, buffers, registers, etc., other embodiments herein can include a hardware platform such as a computerized device (e.g., a computer processor system, a host computer, personal computer, workstation, etc.) that is configured to support the aforementioned techniques of backfilling set of pointers inserted into respective data streams. In such embodiments, the computerized device includes a memory system, a processor (e.g., a processing device), and a respective interconnect. The interconnect couples the processor to the memory system. The memory system is encoded with an application (e.g., software code) that, when executed on the processor, produces a navigable data stream.

Yet other embodiments of the present application disclosed herein includes software programs to perform the method embodiment and operations summarized above and disclosed in detail below. More particularly, embodiments herein include a computer program product (e.g., a computer-readable medium) including computer program logic encoded thereon may be executed on a computerized device to produce navigable data streams from a live feed as explained herein. The computer program logic, when executed on at least one processor with a computing system, causes the processor to perform the operations (e.g., the methods) indicated herein as embodiments of the present disclosure. Such arrangements as further disclosed herein are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or an Field Programmable Gate Array (FPGA) or as downloadable software images in one or more modules, shared libraries, etc. The software or firmware or other such configurations can be installed onto a computerized device to cause one or more processors in the computerized device to perform the techniques explained herein.

One more particular embodiment of the present application is directed to a computer program product that includes a computer readable medium having instructions stored thereon for supporting creation, management, and use of navigable data streams according to embodiments herein. The instructions, when carried out by a processor of a respective computer device, cause the processor to perform the steps of: i) allocating a first storage region to maintain a set of pointers associated with a first segment of streaming data; ii) allocating a second storage region to maintain a set of pointers associated with a second segment of the streaming data, a location of the second storage region depending at least in part on a length associated with the first segment of streaming data; and iii) initiating modification to the set of pointers associated with the first storage region. Other embodiments of the present application include software programs to perform any of the method embodiment steps and operations summarized above and disclosed in detail below.

### BRIEF DESCRIPTION OF THE DRAWINGS

The foregoing and other objects, features and advantages of the present application will be apparent from the following more particular description of preferred embodiments, as illustrated in the accompanying drawings in which like reference characters refer to the same parts throughout the different views. The drawings are not necessarily to scale, with emphasis instead being placed upon illustrating example embodiments, principles and concepts.

FIG. 1 is a block diagram of a data stream processor device according to an embodiment herein.

FIG. 2 is a timeline illustrating how a data stream processor initiates a technique of backfilling pointer values for segments of a respective data stream according to an embodiment herein.

FIG. 3 is a timeline illustrating how a data stream processor initiates a technique of backfilling pointer values for segments of a respective data stream according to an embodiment herein.

FIG. 4 is a diagram of a respective data stream including insertion of multiple sets of pointers pointing to future segments according to an embodiment herein.

FIG. 5 is a diagram of a respective data stream including insertion of multiple sets of pointers pointing to future and past segments according to an embodiment herein.

FIG. 6 is a flowchart illustrating a technique of inserting pointers into a respective data stream according to an embodiment herein.

FIGS. 7 and 8 combine to form a flowchart illustrating more specific techniques of inserting pointers into a respective data stream according to an embodiment herein.

### DETAILED DESCRIPTION

The following disclosure includes several useful embodiments for efficiently processing a received data stream (e.g., a live feed) and inserting corresponding sets of pointers (e.g., references, indexes, etc.) The pointers enable navigation amongst the data stream.

For example, each set of pointers inserted into a received data stream eventually includes pointer values that point to other locations (e.g., other segments) within the data stream. However, initially, the pointer values in a respective set of pointers can be set to null values because an address or respective index to other segments or other sets of pointers in the data stream may not be known until a respective following one or more segments are received from the live feed. In other words, a newly created set of pointers cannot point to future index values in the data stream until after knowing a respective length of corresponding one or more following segments associated with the data stream. As new segments of data are received from an original data stream such as a live feed, a processing function herein backfills the null pointer values in the set of pointers with appropriate values to the newly received segments or set of pointers.

As will be discussed, backfilling pointer values previously inserted into the data stream enables a respective user viewing the data stream to initiate navigation amongst the data stream and potentially view a live feed with little or no delay. Accordingly, embodiments herein include a system that converts a received data stream (e.g., a raw data stream of video information) initially with no corresponding set of pointers to a respective data stream including “up-to-date” navigation (e.g., fast forwarding and/or rewind) pointers.

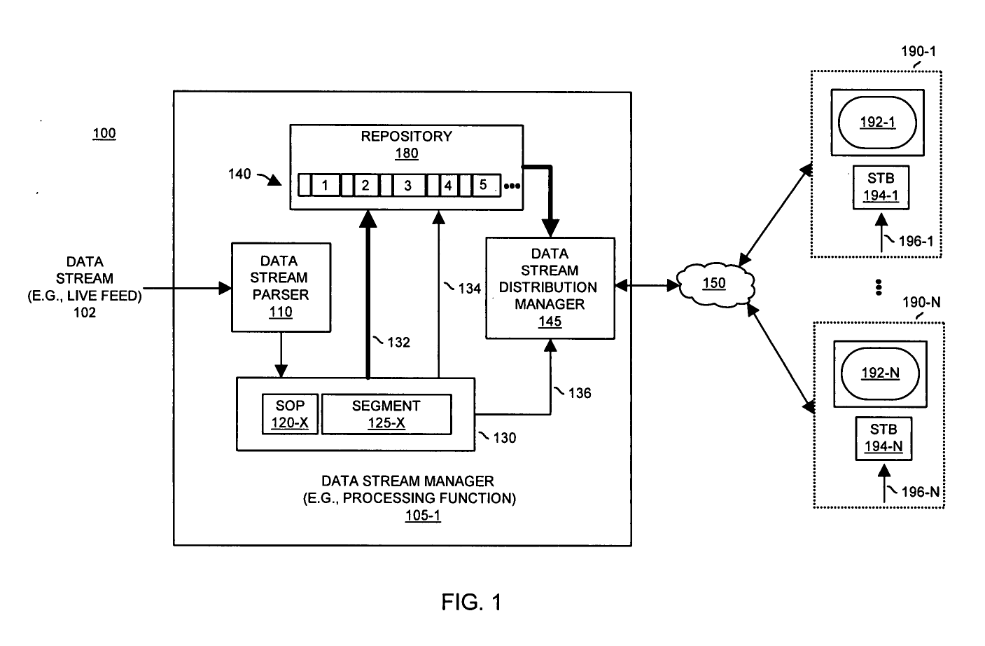

FIG. 1 is a diagram of a data stream manager 105-1 according to embodiments herein. Note that data stream manager 105-1 can simultaneously manage processing of new segments of data, initiate backfilling functionality, and distribution functionality for multiple streams at the same time. The following example embodiment will focus on inserting pointers into data stream 102 (e.g., a live feed received from a remote source) and storing results in repository 180 for clarity sake. However, to achieve processing and distribution of multiple data streams, one embodiment herein involves operating multiple data stream managers 105 in parallel so that multiple users can selectively view each of multiple data streams in near real-time (e.g., delayed) as the segments are received and processed as well as navigate amongst stored portions of received data streams. In other words, data stream manager 105-1 can receive multiple live feeds at the same time and insert/backfill pointer values into each of the data streams.

In the context of the present example, communication system 100 (e.g., a data streaming system) includes data stream manager 105-1, network 150, and multiple user domains 190 (e.g., home environments) for viewing video information, listening to audio information, etc. In one embodiment, data stream manager 105-1 includes a data stream parser 110, buffer 130 (that stores a current set of pointers 120-X and content segment 125-X), repository 180, and data stream distribution manager 145. Each of the user domains 190 can include a respective display screen 192 (e.g., television, computer system, media player, etc.) and set top box 194.

According to one implementation, a respective user (e.g., subscriber) associated with a user domain 190-1 provides input signals 196-1 to a respective set top box 194-1 for purposes of controlling streaming of video and/or audio information to be played back by a respective media player 192-1 (e.g., television, video player, music player, etc.). In such an implementation, a respective set top box 194-1 communicates input control signals 196-1 received from the respective users over network 150 to data stream distribution manager 145 of data stream manager 105-1.

Based on commands received from a respective user over network 150, data stream distribution manager 145 streams the appropriate data associated with a selected stream from repository 180 or buffer 130 to the respective user domain 190. Accordingly, each home environment can include a relatively simple set top box 194 that enables a respective user to receive (e.g., streaming data) and transmit (e.g., input commands) over network 150. In one embodiment, the data stream manager 105-1 can be considered a centralized location that processes and distributes many data streams depending on user requests.

One purpose of data stream manager 105-1 is to enable users at domains 190 to view respective data streams in real-time or as near a real-time manner as possible. Based on input, respective users can navigate amongst a respective data stream using navigation (e.g., fast forward and rewind) functionality. The term live feed includes any pre-recorded information as well as live broadcasts received from a remote source that has not yet been completely processed by the data stream manager 105-1. An object of one embodiment is to insert sets of pointers into a live feed for local storage as well as forward contents of the data stream 102 over network 150 to users.

As discussed above, initially, pointer values in a respective set of pointers inserted into a received data stream (e.g., live feed such as a pre-recorded video information) can be set to null values because an address or respective index to other segments or other sets of pointers in the data stream may not be known until a following segment or future segments have been received from data stream 102. That is, a set of pointers associated with a newly received segment of a live feed data stream 102 cannot point to future index values in the data stream until after knowing a respective length of corresponding one or more following segments of data stream 102.

As successive segments of data are received from an original live data stream, a processing function herein backfills the null pointer values in the set of pointers with appropriate values to the newly received segments or set of pointers. As will be discussed, backfilling null or temporary pointer values previously inserted into the data stream enables a respective user viewing the data stream to initiate navigation amongst the data stream and potentially view a live feed with little or no delay. Accordingly, a system herein converts a received data stream (e.g., a raw data stream of video information) initially with no corresponding set of pointers to a respective data stream including “up-to-date” navigation (e.g., fast forwarding and/or rewind) pointers.

Upon receipt of data stream 102 (e.g., a live feed) as shown in FIG. 1, data stream parser 110 parses and stores a current segment of the data stream 102 in buffer 130. Initially, the data stream manager 105-1 creates a null set of pointers 120-X associated with a current segment 125-X in buffer 130. In other words, for each of a first, second, third, etc. segment (e.g., a set of digital data defining a so-called group of pictures) received in data stream 102, the data stream manager 105-1 stores a respective segment (e.g., length of data content) and creates a respective set of pointers (e.g., one or more pointers) associated with the segment in buffer 130. As mentioned, the set of pointer 120-X can include a single pointer or multiple pointers that point to other locations (e.g., other inserted sets of pointers) in the data stream 102.

As will be discussed further in this specification, a set of pointers can include pointers that point to future segments in the data stream as well as pointers to segments earlier in the data stream. The forward pointers in a given set of pointers are initially set to null values because, at a time of initial processing, it is not yet known what the value of the forward pointers will be until future segments are received by the data stream manager 105-1. Accordingly, upon receipt of each new segment of data stream 102, the data stream manager 105-1 creates a respective set of null pointers in buffer 130 for yet to be received portions of data stream 102. Since a position of previous segments in data stream 102 is already known, the data stream manager 105-1 can immediately fill in the backward-looking pointers into set of pointers 120-X in lieu of populating the set of pointers 120-X with null pointer values. Upon transferring a recently received segment of data stream 102 and corresponding set of pointers from buffer 130 to repository 180, data stream manager 105-1 notifies the data stream distribution manager 145 that the new segment can be streamed to a respective one or more user over network 150.

In one embodiment, the pointers support transitions into or out of play and pause modes. Part of a set of pointers can include pointers for forward and reverse pictures as well as contain a respective pointer for a current picture for completeness of all possible navigation commands. A so-called current pointer can be used to start playing from or as a location to stop playing at. The current pointer also can be used to loop on itself when in pause where the stream keeps going back to the start of the current picture once the picture has been displayed. Fast forward and rewind can be considered a moving pause; it is just a matter of what picture is displayed or from a PTP point of view, what pointer is chosen to jump to.

As discussed above and further in this disclosure, the forward pointers in a so-called PTP (e.g., metadata including a set of pointers) get updated after the PTP and its corresponding GOP (Group Of Pictures) gets written to memory, and the latency time to start playing an ingesting content is dramatically reduced due to the fact that we can start writing the content to BFD memory even before the first complete picture has been ingested and analyzed.

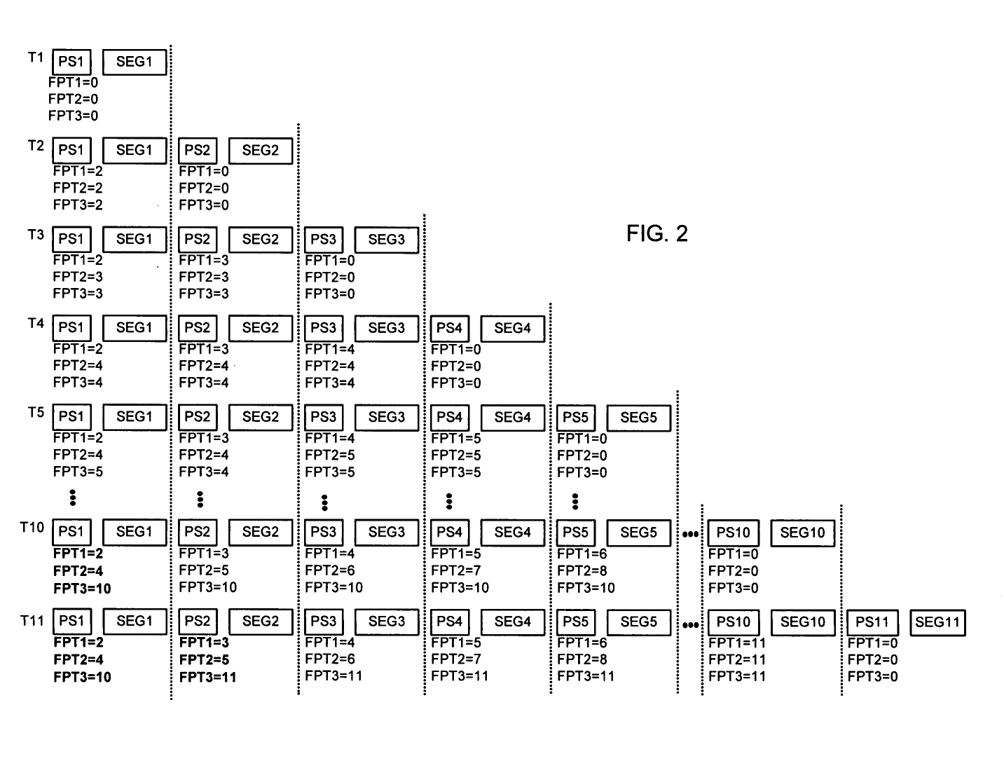

According to embodiments herein, the current pointer and reverse pointers of the PTP never need to be updated in the same way as the forward pointers because the ingest analyzer knows about the past and present but not the future at a respective time of the initially writing a portion of the stream to memory. Accordingly, techniques herein enable a user to be able to pause, rewind, fast forward, and play much sooner (or closer to a tip of a live feed). FIG. 2 is a time chart illustrating processing of data stream 102 according to embodiments herein.

At cycle time T1 (e.g., a first processing cycle), data stream manager 105-1 receives segment 1 from data stream 102 and stores segment 1 in corresponding buffer 130. For example, data stream manager 105-1 stores segment 1 in segment 125-X of buffer 130. As discussed above, segment 1 can represent a logical grouping of most recently received data (e.g., a group of sequentially displayed video pictures) associated with a live feed received from a remote source.

For segment 1, data stream manager 105-1 creates a corresponding set of pointers 120-X to include FPT1 (e.g., forward pointer 1), FPT2, and FPT3. The number of forward pointers can vary depending on the respective application from a single pointer to many pointers.

Upon creation of set of pointer PS1, the data stream manager 105-1 initially sets FPT1, FPT2, and FPT3 in PS1 to a null value such as zero because it is not yet specifically known which future segment the pointers in PS1 will point. After creating set of pointers PS1 in buffer (e.g., as set of pointer 125-X, where X=1), the data stream manager 105-1 transfers the set of pointers PS1 and corresponding segment 1 to repository 180. After this initial processing, the data stream distribution manager 145 of data stream manager 105-1 can potentially stream segment 1 out to corresponding viewers at domains 190 that happen to be requesting display of data stream 102 in as near real-time as possible on a respective media player. The data stream manager 105-1 may impart a small delay (e.g., 0.25 to 1.0 seconds due to processing) in a path from the source generating the data stream 102 and target recipients such as respective users at domains 190.

During cycle time T2 (e.g., a second segment processing cycle), the data stream manager 105-1 transfers initial contents (e.g., set of pointers PS1 in set of pointers 120-X and segment 1 in segment 125-X) of buffer 130 into repository 180.

After flushing buffer 130 of its content, data stream manager 105-1 then stores a next received segment (e.g., segment #2) associated with data stream 102 into buffer 130. The data stream manager 105-1 repeats the above process of creating a respective set of pointers associated with segment #2. For example, the data stream manager 105-1 creates a new set of pointers for each newly received segment.

Each forward pointer in a respective newly created set of pointers eventually is backfilled to reference future segments of data stream 102 stored in repository 180. Again, since the values of the pointers are initially unknown at a time of creating a respective set of pointers, the data stream manager 105-1 sets respective pointer values to zero (e.g., a null value not pointing to a valid location in stored data stream 140. For example, at time T1, data stream manager 105-1 sets FPT1, FPT2, and FPT3 of set of pointer PS1 to null values such as zero because it is not yet know of a location of future segments in repository 180. At time T2, data stream manager 105-1 sets FPT1, FPT2, and FPT3 of set of pointer PS2 to null values such as zero because it is not yet know of a location of future segments in repository 180. At time T3, data stream manager 105-1 sets FPT1, FPT2, and FPT3 of set of pointer PS3 to null values such as zero because it is not yet know of a location of future segments in repository 180, and so on.

Note that data stream manager 105-1 can update pointer values for previously created sets of pointers associated with corresponding received segments. For example, during cycle T2, the data stream manager 105-1 can backfill set of pointers PS1 to point to future segment 2 of data stream 102 because, at this later point in time, it is known where set of pointers PS2 and/or segment 2 will be stored in repository 180. In other words, during cycle time T2, data stream manager 105-1 sets FPT1, FPT2, and FPT3 of set of pointers PS1 to respective address values of corresponding locations where set of pointers PS2 reside in the data stream 140 stored in repository 180. During cycle time T3, data stream manager 105-1 sets FPT1, FPT2, and FPT3 of set of pointers PS1 to respective address values of corresponding locations where set of pointers PS2 and PS3 reside in the data stream 140 stored in repository 180. In cycle T3, the data stream manager 105-1 also sets FPT1, FPT2, and FPT3 of set of pointers PS2 to respective address values of corresponding locations where set of pointers PS3 reside in the data stream 140 stored in repository 180. By cycle time T10, the data stream manager 105-1 completely backfills set of pointers PS1 to final pointer values. For example, FPT1 points to a respective storage location associated with segment 2, FPT2 points to a respective storage location associated with segment 4, FPT3 points to a respective storage location associated with segment 10, and so on.

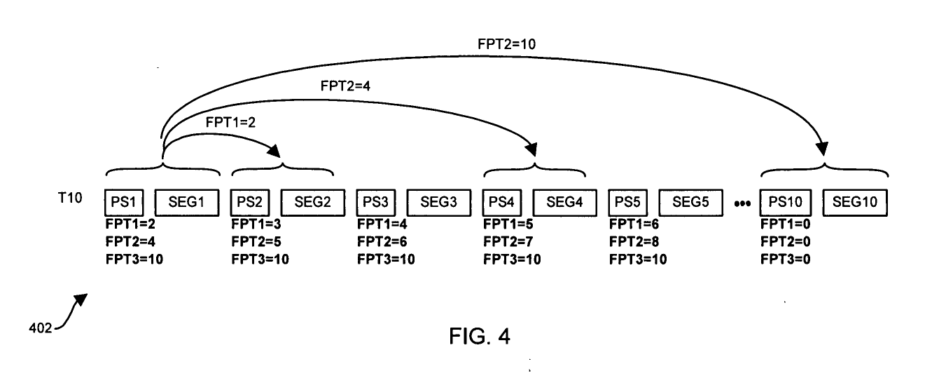

Note that FIG. 4 includes a diagram of a finalized sets of pointers that point to future segments in a respective stored data stream 402 including inserted set of pointers created by data stream manager 105-1. Data stream 402 includes encoded information associated with data stream 102 as well as inserted sets of pointers PS1, PS2, PS3, and so on.

As shown in FIG. 4, data stream manager 105-1 has completed a respective backfilling process such that set of pointer PS1 associated with segment 1 points to multiple other locations in the respective data stream 402. For example, pointer FPT1 in PS1 has been backfilled with an address or pointer value to point to set of pointers PS2 and/or segment #2, pointer FPT2 in PS1 has been backfilled with an address or pointer value to point to set of pointers PS4 and/or segment #4 pointer, FPT3 in PS1 has been backfilled with an address or pointer value to point to set of pointers PS110 and/or segment #10, and so on.

Accordingly, embodiments herein include a technique of modifying one or more pointers in a respective data stream to point to: i) an address associated with the future storage regions (e.g., FPT1 associated with PS1 can be modified to point to the storage region that stores set of pointers PS2 and corresponding segment 2), ii) a set of pointers associated with a future segment (e.g., FPT1 associated with PS1 can point to set of pointers PS2), and/or iii) a following segment in a data stream (e.g., FPT1 associated with PS1 can point to future segment 2).

In one embodiment, a respective forward pointer in a corresponding set of pointers points to a beginning address location of the set of pointers associated with a following segment. For example, as shown in FIG. 4, FPT1 in each set of pointers can point to an address of a set of pointer associated with a following segment, FPT2 points to an address of a set of pointers associated with a respective third following segment, FPT3 points to an address of a set of pointers associated with a ninth following segment, and so on.

Referring again to FIG. 2, the data stream manager 105-1 can store the sets of pointers and corresponding segments of data stream 102 such that sets of pointers are inserted into a respective received data stream 102 to produce data stream 140 stored in repository 180. As mentioned, sizes of the respective segments of the data stream 102 are not known until received by the data stream manager 105-1. Accordingly, the data stream manager 105-1 is unable to initially create appropriate values for each set of pointers.

However, as discussed above, eventually, the data stream manager 105-1 receives enough future segments of the data stream 102 and is able to backfill appropriate values associated with the sets of pointers. For example, by time cycle T10, the data stream manager 105-1 is able to create a final set of pointer values for PS1 associated with segment 1. By cycle T11, the data stream manager 105-1 is able to create a final set of pointer values for set of pointer PS2 and corresponding segment 2, and so on.

Accordingly, embodiments herein include a technique of maintaining multiple segments of data as a respective stream of data including corresponding inserted sets of pointers. Each of the respective sets of pointers inserted into a data stream includes pointers to multiple locations within the respective stream. As will be discussed further in this specification, the pointers enable a respective user to skip to different locations in the respective stream of data.

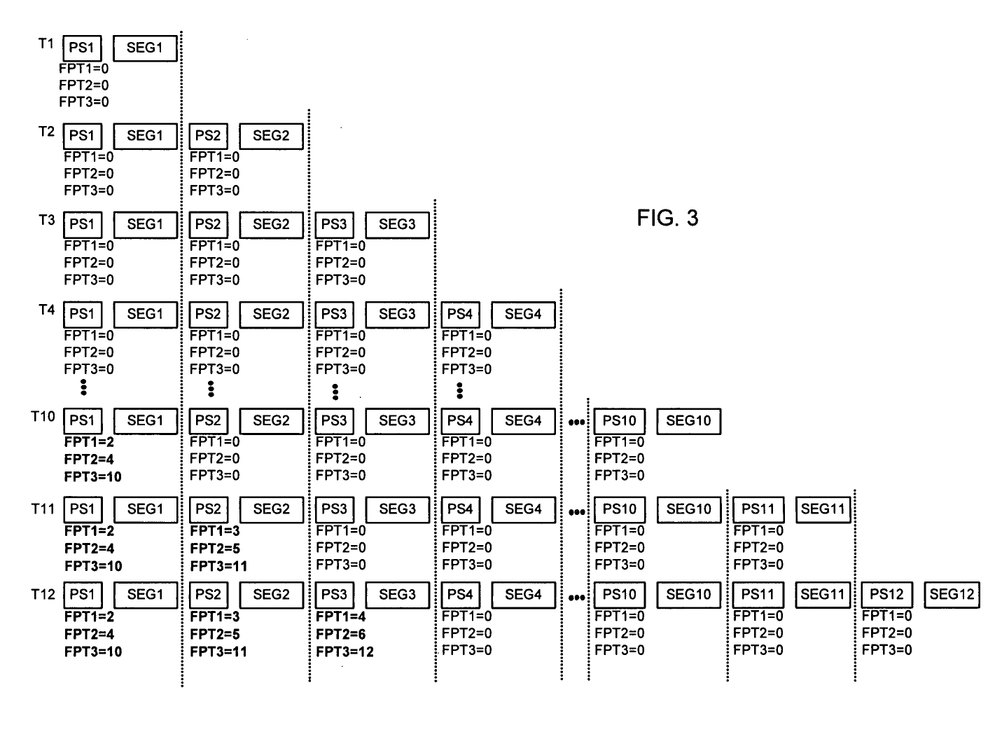

FIG. 3 is a diagram of respective cycles illustrating processing of data stream 102 according to embodiments herein. In this case, the data stream manager 105-1 does not perform partial backfilling of pointer values. Instead, the data stream manager 105-1 backfills a respective set of pointers when enough future segments of the data stream 102 have been received and processed by data stream manager 105-1.

More specifically, data stream manager 105-1 creates and inserts sets of pointers into received data stream 102 that is stored as data stream 402 in repository 180. However, the data stream manager 105-1 does not backfill appropriate pointer values in the set of pointers until the data stream manager 105-1 is able to create final pointer values for each pointer in a respective set of pointers. For example, up until cycle T10, the pointer values in set of pointer PS1 includes all null values of zero. At cycle T10, the data stream manager 105-1 backfills FPT1, FPT2, and FPT3 with respective address values pointing to future set of pointers and/or segments. At cycle time T11, the data stream manager 105-1 backfills set of pointer PS2. At cycle time T12, the data stream manager 105-1 backfills pointer values associated with set of pointer PS3, and so on.

As discussed herein, data stream manager 105-1 enables a respective user to fast-forward to a “tip” of a respective live ingest (e.g., data stream 102) by jumping over “null pointers” (those which have not yet been filled in yet). Conversely, the data stream manager 105-1 enables a user to jump back from the tip to a set of pointers which have been filled in created for a respective data stream 102. This can be accomplished by have two additional pointers called “last address” and “last completed address.” Each time a data segment is loaded, “last address” is updated to this value. Each time a set of pointers is completed, “last completed address” is updated to this value.

During fast-forward, the algorithm such as functionality provided by the data stream manager 105-1 eventually reaches a segment where the forward-pointers have not been completed. At this point, the code jumps to “last address” (which is the live tip of data stream 102), and drops to normal play.

If the user is at the live play tip, the rewind pointers have yet to be filled in. As expected, in this case, the algorithm can jump back to “last completed address” and begin to rewind from there. Accordingly, a respective user can view a live tip (or near live tip) of data stream 102 and also execute rewind capabilities with respect to stored portions of the data stream 102.

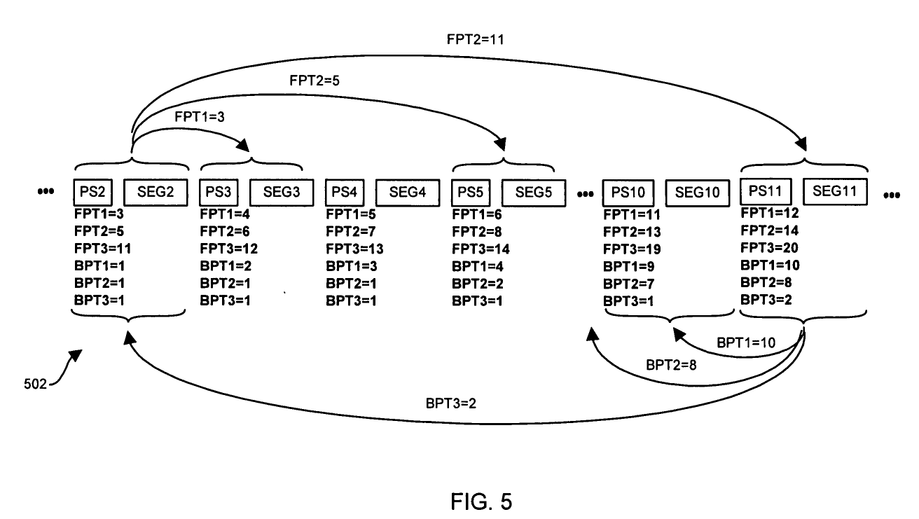

FIG. 5 is a diagram of sets of pointers inserted into a respective stored data stream 502 according to embodiments herein. As discussed above, each set of pointers (e.g., PS1, PS2, etc.) can include forward pointers (e.g., FPT1, FPT2, FPT3, etc.) and backward pointers (e.g., BPT1, BPT2, BPT3, etc.). As shown, one embodiment herein includes storing each of multiple sets of pointers associated with the respective segments in a contiguous manner in a same or common data stream. In other words, a processed data stream 140 stored in repository 180 can include a first set of pointers followed by a first segment, a second set of pointers followed by a second segment, a third set of pointers followed by a third segment, etc.

Referring briefly again to FIG. 1, one purpose of the forward and backward pointers into a received data stream 102 is to enable a respective user to control which portion of a respective data stream stored in repository 180 to playback on a respective media player. For example, the inserted forward and backward pointers enable the respective user to perform navigation such as fast forward and rewind functions at different rates.

Assume that a respective user at environment 190-1 generates input 196-1 (e.g., via a remote control device) to fast forward a current viewing point associated with stored data stream 140 in repository 180. Data stream distribution manager 145 receives this command over network 150 and thereafter uses the forward pointers in a respective data stream 140 to jump ahead and stream data from a different location in data stream 140 over network 150 to the user. Forward pointers FPT1 enable a first rate of fast forwarding, forward pointers FPT2 enable a second rate of fast forwarding, forward pointers FPT3 enable a third rate of fast forwarding, and so on. Of course the user is unable to fast forward viewing of a respective data stream 102 beyond a current position of a live or current feed such as data stream 102 being received and processed by data stream manager 105-1.

Insertion of pointers into a received data stream enable a respective user to control a rate of viewing the streaming data approximately up to a current position of the live feed such as closer to the real-time feed received by the data stream manager 105-1. This small amount of delay can occur as a result of the data stream manager 105-1 processing a most recently received segment of the data stream 102 while data stream distribution manager 145 feeds a previously processed segment to the respective user (or users) over network 150.

In one embodiment, network 150 represents a network such the Internet, a wide area network, a local area network, etc. Accordingly, the data stream manager 105-1 acts as a centralized location that manages streaming of data to multiple different locations such as environments 190.

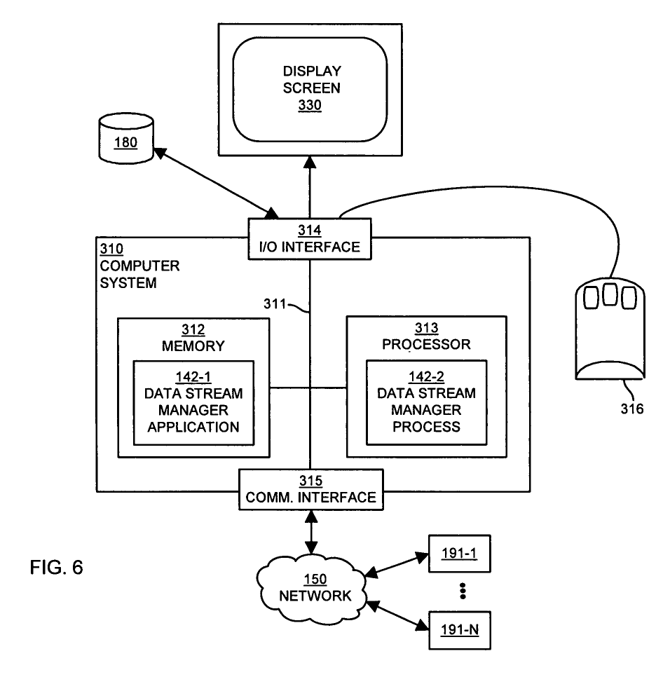

FIGS. 1-5 describe the functionality associated with data stream manager processing function 105-1 according to an embodiment herein. FIG. 6 is a diagram illustrating a sample architecture for implementing one or more processing functions according to an embodiment herein.

As shown, data stream manager 105-1 can be implemented in a respective computer system including a processor 113 and corresponding software code (e.g., scheduler application 140-1) to carry out the embodiments discussed in this specification. As an alternative to an embodiment as shown in FIG. 6, the data stream manager 105-1 can be implemented via hardware components such as logic gates, buffers, etc. or combination of both types of suitable hardware and software resources.

As shown in FIG. 6, computer system 310 of the present example includes an interconnect 311 that couples a memory system 312, a processor 313, an input/output interface 314, and a communications interface 315. Input/output interface 314 enables computer system 310 to communicate with peripheral device such as repository 180, data stream 330, handheld mouse, etc. A computer system 310 implementing data stream manager 105-1 can include all, some or none of these peripheral devices. Communications interface 315 enables computer system 310 to distribute streaming data to different target user environments 190.

As shown, memory system 312 is encoded with a data stream manager application 142-1 supporting the functionality of inserting pointer values into streaming data and amending the pointer values as new segments of the streaming data are received and processed. Data stream manager application 142-1 can be embodied as software code such as data and/or logic instructions (e.g., code stored in the memory or on another computer readable medium such as a disk) that support processing functionality according to different embodiments described herein. During operation, processor 313 accesses memory system 312 via the interconnect 311 in order to launch, run, execute, interpret or otherwise perform the logic instructions of the data stream manager application 142-1. Execution of data stream manager application 142-1 produces processing functionality in data stream manager process 142-2. In other words, the data stream manager process 142-2 represents one or more portions of the data stream manager 105-1 as discussed above in FIG. 1.

It should be noted that the data stream manager application 142-1 executed in computer system 310 is represented in FIG. 6 by either one or both of the data stream manager application 142-1 and/or the data stream manager process 142-2. For purposes of this discussion, general reference will be made to the data stream manager 105-1 as performing or supporting the various steps and functional operations to carry out techniques discussed herein.

It should also be noted that example configurations herein include the data stream manager application 142-1 itself (i.e., the un-executed or non-performing logic instructions and/or data). The data stream manager application 142-1 may be stored on a computer readable medium (such as a floppy disk), hard disk, or optical medium. The data stream manager application 142-1 may also be stored in a memory system 312 such as in firmware, read only memory (ROM), or, as in this example, as executable code in, for example, Random Access Memory (RAM). In addition to these embodiments, it should also be noted that other embodiments herein include the execution of data stream manager application 142-1 in processor 313 as the scheduler process 142-2. Thus, those skilled in the art will understand that the data communication device may include other processes and/or software and hardware components to carry out functionality described herein.

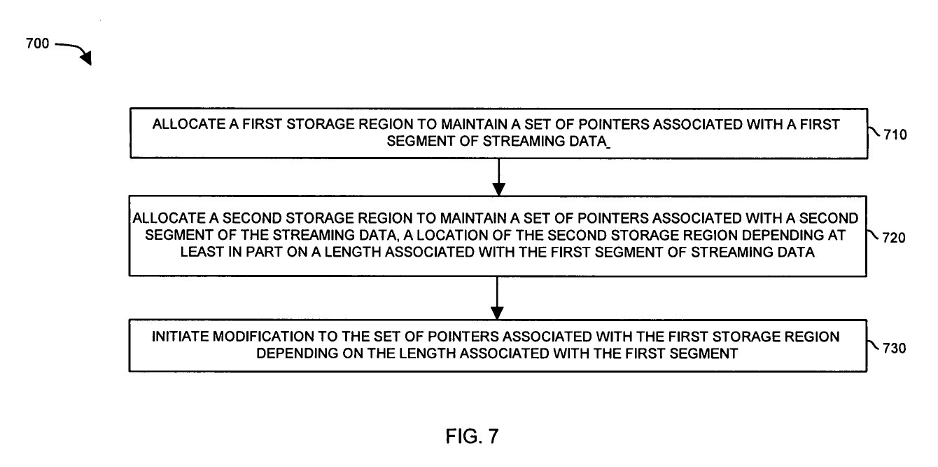

FIG. 7 is a flowchart 700 illustrating a technique of backfilling values of pointers associated with a data stream according to an embodiment herein. Note that FIG. 7 will be described with respect to the embodiments as discussed with respect to FIGS. 1-6. Also, as mentioned above, note that data stream manager 105-1 and related functionality can be implemented in hardware and/or software.

In step 710, the data stream manager 105-1 initiates allocation of a first storage region in repository 180 to maintain a set of pointers associated with a first received segment of streaming data 102.

In step 720, the data stream manager 105-1 initiates allocation of a second storage region in repository 180 to maintain a set of pointers associated with a second segment of the streaming data. A location such as an address of the second storage region for storing respective pointers depends at least in part on a length associated with the first segment of streaming data.

In step 730, the data stream manager 105-1 initiates modification to the set of pointers (e.g., one or more pointers) associated with the first storage region depending on the length associated with the first segment. In other words, the data stream manager 105-1 initiates modification to the set of pointers associated with the first storage region to reference the second storage region in repository 180. In one embodiment, the data stream manager 105-1 achieves this end by backfilling pointer values in the sets of pointers depending on lengths of the future received segments.

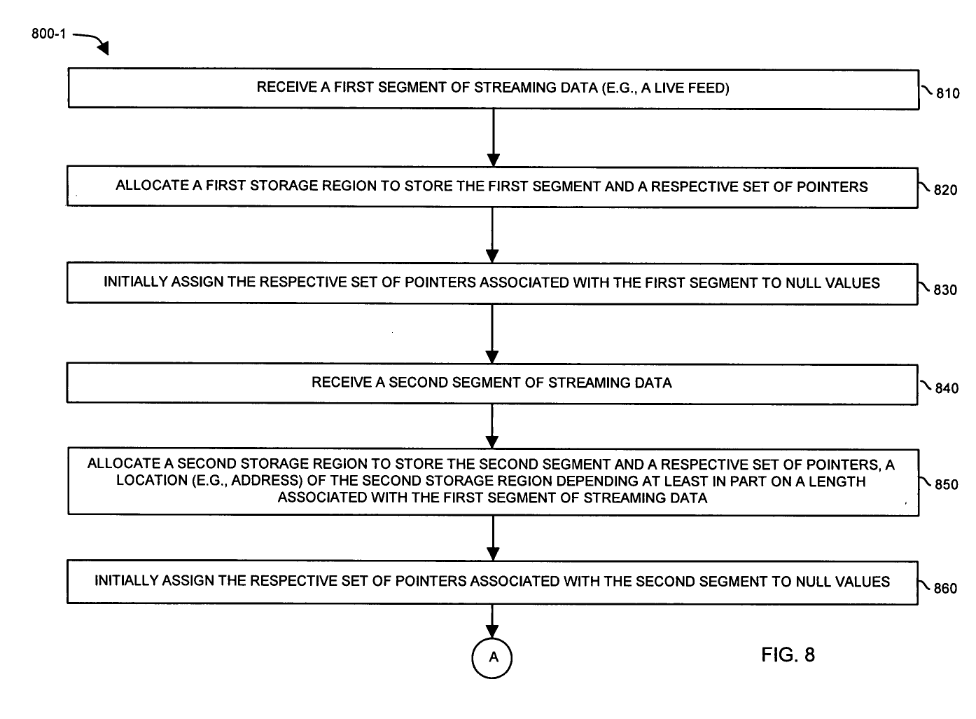

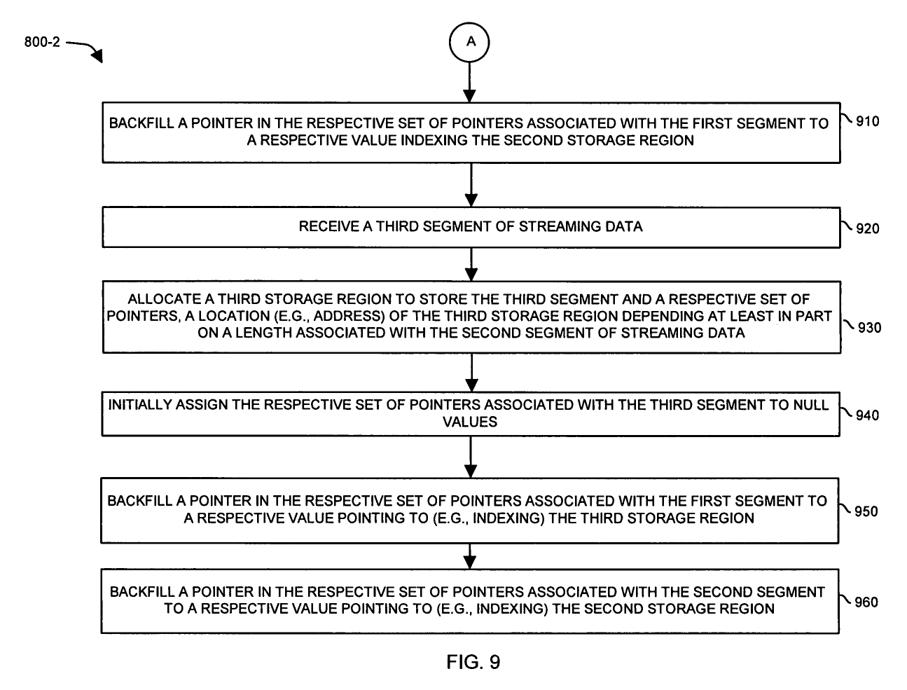

FIGS. 8 and 9 combine to form a flowchart 800 (e.g., flowchart 800-1 and flowchart 800-2) illustrating a technique of inserting pointers into streaming data, backfilling pointer values, etc. according to an embodiment herein.

In step 810, the data stream manager 105-1 receives a first segment of streaming data (e.g., a live feed such as pre-recorded video stream).

In step 820, the data stream manager 105-1 allocates a first storage region in repository 180 to store the first segment and a respective set of pointers (e.g., PS1) associated with the first segment.

In step 830, the data stream manager 105-1 initially assigns the respective set of pointers associated with the first segment to null values (e.g., meaningless values such as zeros).

In step 840, the data stream manager 105-1 receives a second segment of streaming data. For example, the data stream manager 105-1 receives the second segment after completing processing associated with the first segment.

In step 850, the data stream manager 105-1 allocates a second storage region in repository 180 to store the second segment and a respective set of pointers. In one embodiment, a respective location (e.g., address) of the second storage region depends at least in part on a length associated with the first segment of streaming data because the set of pointers associated with the second region is stored (e.g., address-wise) after the first segment but before the second segment.

In step 860, the data stream manager 105-1 initially assigns the respective set of pointers associated with the second segment to null values.

In step 910 of flowchart 800-2 shown in FIG. 9, the data stream manager 105-1 backfills a pointer (e.g., overwrites a null value or outdated value associated with a pointer) in the respective set of pointers associated with the first segment to a respective value indexing the second storage region. In other words, the data stream manager 105-1 modifies or updates the pointer to an address in the second storage region. In one embodiment, the updated pointer value points to a start address associated with the second storage region or second set of pointers.

In step 920, the data stream manager 105-1 receives a third segment of streaming data.

In step 930, the data stream manager 105-1 allocates a third storage region to store the third segment and a respective set of pointers (e.g., a third set of pointers). In one embodiment, a respective location (e.g., address) of the third storage region (e.g., third set of pointers) depends at least in part on a length associated with the second segment of streaming data. The set of pointers associated with the third region is stored (e.g., address-wise) after the second segment but before the third segment of streaming data.

In step 940, the data stream manager 105-1 initially assigns the respective set of pointers associated with the third segment to null values.

In step 950, the data stream manager 105-1 backfills a pointer (e.g., overwrites a null value or outdated value) in the respective set of pointers associated with the first segment to a respective value pointing to (e.g., indexing) the third storage region. In other words, in one embodiment, the data stream manager 105-1 modifies or updates a pointer (in the set of pointers associated with the first segment) to an address in the second storage region. In one embodiment, the data stream manager 105-1 can update a respective pointer value to point to a start address associated with the second storage region.

In step 960, the data stream manager 105-1 backfills a pointer in the respective set of pointers associated with the second segment to a respective value pointing to (e.g., indexing) the third storage region. In other words, in one embodiment, the data stream manager 105-1 modifies or updates a pointer (in the set of pointers associated with the second segment) to an address in the third storage region. The data stream manager 105-1 can update a respective pointer value to point to a start address associated with the third storage region.

As discussed, techniques herein are well suited for use in applications such as backfilling pointer values inserted into streaming data. However, it should be noted that configurations herein are not limited to use in such applications and thus configurations herein and deviations thereof are well suited for other applications as well.

While this invention has been particularly shown and described with references to preferred embodiments thereof, it will be understood by those skilled in the art that various changes in form and details may be made therein without departing from the spirit and scope of the invention as defined by the appended claims. Such variations are intended to be covered by the scope of this invention. As such, the foregoing description of embodiments of the invention is not intended to be limiting. Rather, any limitations to embodiments of the invention are presented in the following claims.

What is claimed is:

1. A method comprising:
allocating a first storage region to maintain a set of pointers associated with a first segment of streaming data;
after allocating the first storage region and receiving the first segment of streaming data, allocating a second storage region to maintain a set of pointers associated with a second segment of the streaming data, a location of the second storage region depending at least in part on a length associated with the first segment of streaming data; and
initiating modification to the set of pointers associated with the first storage region to reference the second storage region.

2. A method as in claim 1, wherein initiating modification of the set of pointers associated with the first storage region includes:
modifying the set of pointers associated with the first segment to include a pointer to an address associated with the second storage region that stores the set of pointers associated with the second segment, at least one pointer in the set of pointers associated with the first segment being dependent on the length associated with the first segment.

3. A method as in claim 1, wherein initiating modification of the set of pointers associated with the first storage region includes:
modifying the set of pointers associated with the first segment to include a pointer to an address associated with at least one of: i) the second storage region, ii) the set of pointers associated with the second segment, and iii) the second segment.

4. A method as in claim 1 further comprising:
after allocating the second storage region and receiving the second segment, allocating a third storage region to maintain a set of pointers associated with a third segment of the streaming data, a location of the third storage region depending at least in part on a length associated with the second segment; and
initiating modification of pointer values in the set of pointers associated with the first storage region depending on the length associated with the second segment.

5. A method as in claim 4, wherein initiating modification of the set of pointers associated with the first storage region depending on the length associated with the second segment includes:
modifying the set of pointers associated with the first segment to include a pointer to an address associated with the third storage region that stores the set of pointers associated with the third segment.

6. A method as in claim 1 further comprising:
after allocating the second storage region and receiving the second segment, allocating a third storage region to maintain a set of pointers associated with a third segment of the streaming data, a location of the third storage region depending on a length associated with the second segment; and
maintaining the first segment, the second segment, and the third segment as a respective stream of data including corresponding inserted sets of pointers, each of which includes pointers to multiple locations within the respective stream, the pointers enabling a respective user to skip to different locations in the respective stream of data based on respective input.

7. A method as in claim 1 further comprising:
allocating a third storage region to maintain a set of pointers associated with a third segment of the streaming data;
maintaining a respective stream of data at least partially derived from the streaming data to include inserted sets of pointers, the inserted set of pointers including the first storage region, the second storage region, and the third storage region;
maintaining the first storage region to include a respective pointer to an address associated with the second storage region; and
maintaining the second storage region to include a respective pointer to an address associated with the third storage region.

8. A method as in claim 1 further comprising:
allocating a third storage region to maintain a set of pointers associated with a third segment of the streaming data;
maintaining a respective stream of data at least partially derived from the streaming data to include inserted sets of pointers including the first storage region, the second storage region, and the third storage region; and
maintaining the second storage region to include: i) a first pointer to an address associated with the first storage region, an ii) a second pointer to an address associated with the third storage region.

9. A method as in claim 1 further comprising:
allocating a third storage region to maintain a set of pointers associated with a third segment of the streaming data;
maintaining a respective stream of data at least partially derived from the streaming data to include inserted sets of pointers, the inserted set of pointers including the first storage region, the second storage region, and the third storage region; and
maintaining the first storage region to include: i) a first pointer to an address associated with the second storage region, and ii) a second pointer to an address associated with the third storage region, the first pointer and the second pointer enabling multiple fast forwarding speeds when the respective stream of data is played back.

10. A method as in claim 1, wherein allocating the first storage region occurs in response to receiving the first segment of streaming data approximately in a real-time manner;
wherein allocating the second storage region occurs in response to receiving the second segment of streaming data in a real-time manner after receiving the first segment of streaming data; and
wherein initiating modification of the set of pointers includes backfilling values associated with the set of pointers after processing the second segment.

11. A method as in claim 1 further comprising:
receiving the streaming data as a live feed from a remote source; and
initiating the modification of the set of pointers for purposes of enabling a respective user to control a rate of viewing the streaming data approximately up to a current position of the live feed.

12. A method as in claim 1 further comprising:
receiving the streaming data as a live feed from a remote source; and
initiating the insertion and backfilling of the set of pointers associated with the first storage region and second storage region for purposes of enabling a respective user to control a rate of viewing the streaming data approximately up to a current position of the live feed.

13. A method as in claim 1, wherein initiating the insertion and backfilling enables the respective user to view the live feed with a delay.

14. A method as in claim 1 further comprising:
storing the set of pointers associated with the first segment, the first segment, the set of pointers associated with the second segment, and the second segment in a contiguous manner in a same data stream.

15. A method comprising:
receiving streaming data as a live feed from a remote source;
initially assigning a null value to a given pointer associated with a first received segment of the streaming data; and
after receiving and processing a second segment of the streaming data that follows the first received segment, backfilling the given pointer with an appropriate value pointing to the second received segment.

16. A method as in claim 15 further comprising:
initiating insertion of pointers into the streaming data at different respective intervals depending on sizes of segments associated with the streaming data, each of the pointers initially assigned a respective null value but later being backfilled with appropriate pointer values upon receipt of successive segments.

17. A method as in claim 15, wherein backfilling the given pointer includes setting the given pointer to a value indexing an address associated with a respective future received segment of the streaming data.

18. A method as in claim 15, wherein backfilling the given pointer enables a respective user to control a rate of viewing the streaming data approximately up to a current position of the live feed.

19. A computer program product including a computer-readable medium, the computer readable medium including:
instructions to allocate a first storage region to maintain a set of pointers associated with a first segment of streaming data;
instructions to, after allocating the first storage region, allocate a second storage region to maintain a set of pointers associated with a second segment of the streaming data, a location of the second storage region depending at least in part on a length associated with the first segment of streaming data; and
instructions to initiate modification to the set of pointers associated with the first storage region depending on the length associated with the first segment.

20. An apparatus comprising:
a data stream manager that receives streaming data as a live feed from a remote source, the data stream manager initially assigning a null value to a given pointer associated with a first received segment of the streaming data, the data stream manager backfilling the given pointer with an appropriate value pointing to the second received segment after receiving and processing a second segment of the streaming data.

21. An apparatus as in claim 20, wherein the data stream manager initiates insertion of pointers into the streaming data at different respective intervals depending on sizes of segments associated with the streaming data, each of the pointers initially assigned a respective null value but later being backfilled with appropriate pointer values upon receipt of successive segments of the streaming data.

22. An apparatus as in claim 20, wherein the data stream manager sets the given pointer to a value indexing an address associated with a respective future received segment of the streaming data.

23. An apparatus as in claim 20, wherein the given pointer enables a respective user to control a rate of viewing the streaming data approximately up to a current position of the live feed.
